(19) United States
(12) Patent Application Publication
(10) Pub. No.: US 2017/0198497 A1
(43) Pub. Date: Jul. 13, 2017

(54) PADLOCK AND CABINET LOCK

(71) Applicant: Hong Ting TSAI, San Diego, CA (US)

(72) Inventor: Ming Tang TSAI, Suzhou (CN)

(73) Assignee: Hong Ting TSAI, San Diego, CA (US)

(21) Appl. No.: 15/356,837

(22) Filed: Jan. 23, 2017

(30) Foreign Application Priority Data
Jan. 13, 2016 (CN) 201610021208.0

(51) Int. Cl. E05B 37/00; G07C 9/00; E05B 65/44; E05B 49/00; E05B 67/02; E05B 67/06

(52) U.S. Cl. CPC E05B 37/0068; E05B 67/02; E05B 67/06; E05B 65/44; E05B 49/006; G07C 9/00158; E05B 2047/0089

(57) ABSTRACT

A padlock and cabinet lock fingerprint lockset includes a resetting component, a fingerprint setting switch and a PCBA control module. The fingerprint setting switch is connected to the signal input end of PCBA control module. The fingerprint module has a fingerprint resetting module and a fingerprint initial value setting module which are connected to the signal output end of PCBA control module respectively. The PCBA control module can activate the fingerprint resetting module and fingerprint initial value setting module when the fingerprint setting switch is activated. When the padlock or bolt is pressed down to touch the fingerprint setting switch, the fingerprint setting switch makes the PCBA control module generate a loop by line connection, so as to implement fingerprint initial value setting or fingerprint resetting. The probability of misoperation is low, preventing the failure in opening the fingerprint lock when a child mishandles the fingerprint lock.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to the field of fingerprint locksets, and more particularly to a padlock and cabinet lock.

2. Description of Related Art Including Information Disclosed Under 37 CFR 1.97 And 37 CFR 1.98.

The fingerprint lock is an intelligent lockset, it is a perfect crystallization of computer information technology, electronic technology, mechanical technique and modern hardware technology. The fingerprint has become the most important evidence of identification for its characteristics, and has been extensively used in the fields of police criminal detection and justice. The fingerprint authentication is characterized by convenience, quick speed and precision. With the popularization of technology and the development of smart home, more and more people choose fingerprint lock. The mechanical lock will be substituted in the near future as it is in foreign market. Chinese patent of utility model No. CN 105049405 A published on 2015 Nov. 11, the utility model disclosed a composite fingerprint-based key generation unit and method, authentication system and equipment. The key generation unit comprises multiple fingerprint acquisition modules for collecting the user's fingerprint information; a read unit for reading the sequence of effective fingerprint information and time of press captured by fingerprint acquisition modules; a memory module for storing the effective fingerprint information and the sequence of press and time of press, forming the authentication key. In addition, the key generation unit contains an initial key setting module for the user to set the key for the first time; a key resetting module for resetting a new key according to the user's correct old key. For initial setting or resetting, the key resetting module or initial key setting module shall be activated by touching or pressing buttons on the interface of equipment. The children have a high probability of misoperation, they may fail to open the fingerprint lock.

### BRIEF SUMMARY OF THE INVENTION

In order to overcome the aforesaid defect, the purpose of this utility model is to provide a padlock and cabinet lock with a low probability of misoperation.

In order to attain the aforesaid goal, the technical proposal adopted by this utility model is: a padlock, comprising a padlock housing and a shackle. Said padlock housing is only equipped with a padlock fingerprint module. One end of said shackle is a rotatable end. Said rotatable end is located in the padlock housing and rotatable. A padlock resetting component is mounted at the bottom of rotatable end of said shackle. In addition, said padlock comprises a padlock fingerprint setting switch and a padlock PCBA control module. Said padlock fingerprint setting switch is located on one side of padlock resetting component and under the rotatable end of shackle. Said padlock fingerprint setting switch is connected to the signal input end of padlock PCBA control module. Said padlock fingerprint module comprises a padlock fingerprint resetting module and a padlock fingerprint initial value setting module. Said padlock fingerprint resetting module and padlock fingerprint initial value setting module are connected to the signal output end of padlock PCBA control module respectively. Said shackle can touch the padlock fingerprint setting switch under a downward external force. Said padlock PCBA control module can activate the padlock fingerprint resetting module and padlock fingerprint initial value setting module after the padlock fingerprint setting switch is activated. The beneficial effect of this utility model padlock is that for resetting fingerprint/initial value setting of padlock, the shackle of padlock is turned to opening state, and the shackle is pressed down, the shackle touches the fingerprint setting switch, the padlock fingerprint setting switch makes the padlock PCBA control module generate a loop via line connection, so that the fingerprint initial value setting or fingerprint resetting can be implemented. The probability of misoperation of resetting fingerprint/initial value setting is low, avoiding the failure in opening fingerprint lock when a child mishandles the fingerprint lock. In addition, it is characterized by compactness, low power consumption and extensive application, applicable to volume production.

Preferably, a semicircular boss is located in the lower end of rotatable end of said shackle. Said boss corresponds to padlock fingerprint setting switch up and down. It prevents rotation error of shackle.

Preferably, said padlock fingerprint module contains a padlock fingerprint trigger module. Said padlock fingerprint trigger module comprises a padlock circuit board and a padlock photosensitive chip. Said padlock photosensitive chip is fixed with glue to the chip substrate of padlock circuit board. Said padlock photosensitive chip is electrically connected to padlock circuit board by bonding. There is a padlock trigger switch tab outside said padlock housing. Said padlock trigger switch tab is located between padlock housing and padlock fingerprint module. Said padlock circuit board is connected to padlock PCBA control module via padlock trigger switch tab to form a loop. The padlock photosensitive chip results in high accuracy of fingerprint acquisition. The padlock circuit board is connected to padlock PCBA control module via padlock trigger tab to form a loop. The fingerprint program power switch is activated to read fingerprint information.

Preferably, there are padlock module protection components around and above bonding zone. Said padlock module protection component is holder or/and IR, for protecting padlock photosensitive chip, padlock circuit board and connecting line.

Preferably, the padlock has a padlock battery and a padlock USB external power supply. Said padlock battery and padlock USB external power supply are connected to padlock PCBA control module respectively. When the electric quantity is insufficient for startup, the door lock can be opened by using padlock USB external power supply.

A cabinet lock, comprising a cabinet lock housing, a bolt and a lock barrel. There is only one cabinet lock fingerprint module on said cabinet lock housing. Said lock barrel is located in the cabinet lock housing. A cabinet lock resetting component is mounted at the bottom of said lock barrel. Said bolt is mounted above the lock barrel. As well as a cabinet lock fingerprint setting switch and a cabinet lock PCBA control module. Said cabinet lock fingerprint setting switch is mounted on one side of cabinet lock resetting component and under the lock barrel. Said cabinet lock fingerprint setting switch is connected to the signal input end of cabinet lock PCBA control module. Said cabinet lock fingerprint module comprises a cabinet lock fingerprint resetting module and a cabinet lock fingerprint initial value setting module. Said cabinet lock fingerprint resetting module and cabinet lock fingerprint initial value setting module are connected to the signal output end of cabinet lock PCBA control module respectively. Said bolt is electrically connected to cabinet lock PCBA control module via electromagnetic coil. Said bolt is stretched out or drawn back under electromagnetic control and can drive the lock barrel to press down to touch the cabinet lock fingerprint setting switch. Said cabinet lock PCBA control module can activate the cabinet lock fingerprint resetting module and cabinet lock fingerprint initial value setting module when the cabinet lock fingerprint setting switch is activated. The beneficial effect of this utility model padlock is that for resetting fingerprint/initial value setting of cabinet lock, the bolt is pressed down, the linkage component lock barrel touches the cabinet lock fingerprint setting switch, the cabinet lock fingerprint setting switch makes the PCBA control board generate a loop via line connection, so that the fingerprint initial value setting or fingerprint resetting can be implemented. When the setting is completed, stop pressing down, the bolt linkage component lock barrel is recovered automatically by the lower spring-like cabinet lock resetting component, so as to implement resetting fingerprint/initial value setting for cabinet lock. The probability of mishandling resetting fingerprint/initial value setting is low, avoiding the failure in opening fingerprint lock when a child mishandles the fingerprint lock. In addition, it is characterized by compactness, low power consumption and extensive application, applicable to volume production.

Preferably, a boss is located in the lower end of said lock barrel. Said boss corresponds to cabinet lock fingerprint setting switch up and down.

Preferably, said cabinet lock fingerprint module contains a cabinet lock fingerprint trigger module. Said cabinet lock fingerprint trigger module comprises a cabinet lock circuit board and a cabinet lock photosensitive chip. Said cabinet lock photosensitive chip is fixed with glue to the chip substrate of cabinet lock circuit board. Said cabinet lock photosensitive chip is electrically connected to cabinet lock circuit board by bonding. There is a cabinet lock trigger switch tab outside said cabinet lock housing. Said cabinet lock trigger switch tab is located between cabinet lock housing and cabinet lock fingerprint module. Said cabinet lock circuit board is connected to cabinet lock PCBA control module via cabinet lock trigger switch tab to form a loop. The cabinet lock photosensitive chip results in high accuracy of fingerprint acquisition. The cabinet lock circuit board is connected to cabinet lock PCBA control module via cabinet lock trigger tab to form a loop. The fingerprint program power switch is activated to read fingerprint information.

Preferably, there are cabinet lock module protection components around and above bonding zone. Said cabinet lock module protection component is holder or/and IR, for protecting cabinet lock photosensitive chip, cabinet lock circuit board and connecting line.

Preferably, the cabinet lock has a cabinet lock battery and a cabinet lock USB external power supply. Said cabinet lock battery and cabinet lock USB external power supply are connected to cabinet lock PCBA control module respectively. When the electric quantity is insufficient for startup, the door lock can be opened by using cabinet lock USB external power supply.

### BRIEF DESCRIPTION OF THE SEVERAL VIEWS OF THE DRAWINGS

FIG. 1 is the front view of the padlock embodiment.

FIG. 2 is the sectional view of the padlock embodiment.

FIG. 3 is the close-up view of Part A in FIG. 1.

FIG. 4 is the schematic diagram of the padlock embodiment.

FIG. 5 is the front view of the cabinet lock embodiment.

FIG. 6 is the sectional view of the cabinet lock embodiment.

FIG. 7 is the schematic diagram of structure in the cabinet lock embodiment.

FIG. 8 is the schematic diagram of the cabinet lock embodiment.

Where: 1—padlock; 11—padlock housing; 12—shackle; 13—padlock fingerprint module; 131—padlock fingerprint resetting module; 132—padlock fingerprint initial value setting module; 133—padlock fingerprint trigger module; 133a—padlock circuit board; 133b—padlock photosensitive chip; 14—padlock resetting component; 15—padlock fingerprint setting switch; 16—padlock PCBA control module; 17—padlock trigger switch tab; 18—padlock battery; 19—padlock USB external power supply; 2—cabinet lock; 21—cabinet lock housing; 22—bolt; 23—lock barrel; 24—cabinet lock fingerprint module; 241—cabinet lock fingerprint resetting module; 242—cabinet lock fingerprint initial value setting module; 243—cabinet lock fingerprint trigger module; 243a—cabinet lock circuit board; 243b—cabinet lock photosensitive chip; 25—cabinet lock resetting component; 26—cabinet lock fingerprint setting switch; 27—cabinet lock PCBA control module; 28—cabinet lock trigger switch tab; 29—cabinet lock battery; 210—cabinet lock USB external power supply; 211—electromagnetic coil.

### DETAILED DESCRIPTION OF THE INVENTION

The preferred embodiment of this utility model is elaborated with attached figures below, so that the advantages and features of this utility model are easier for technical personnel of this field to comprehend, and then the scope of protection of this utility model is defined more specifically.

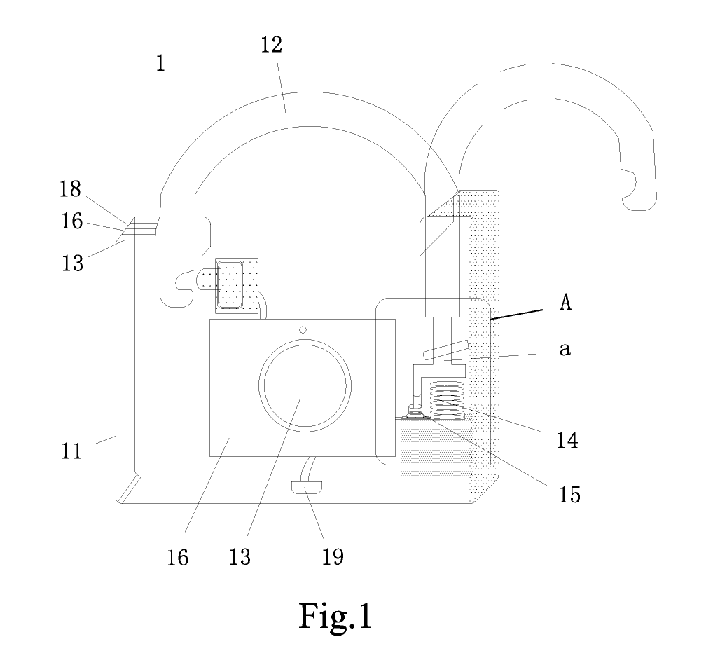

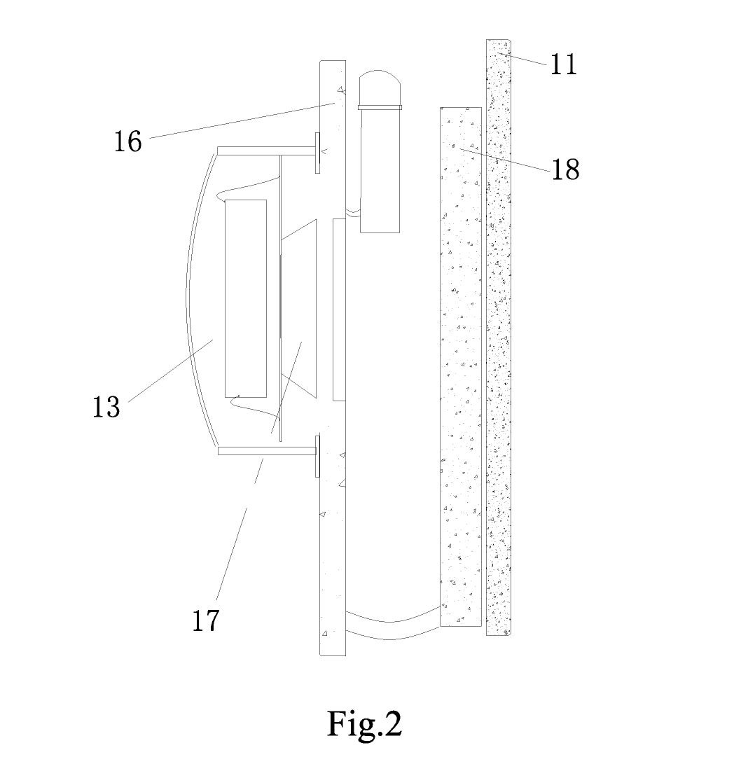

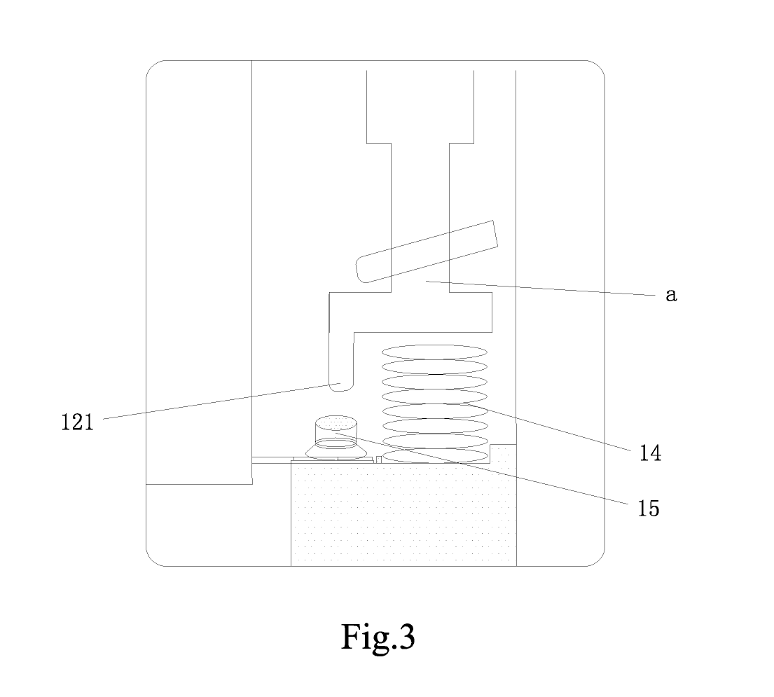

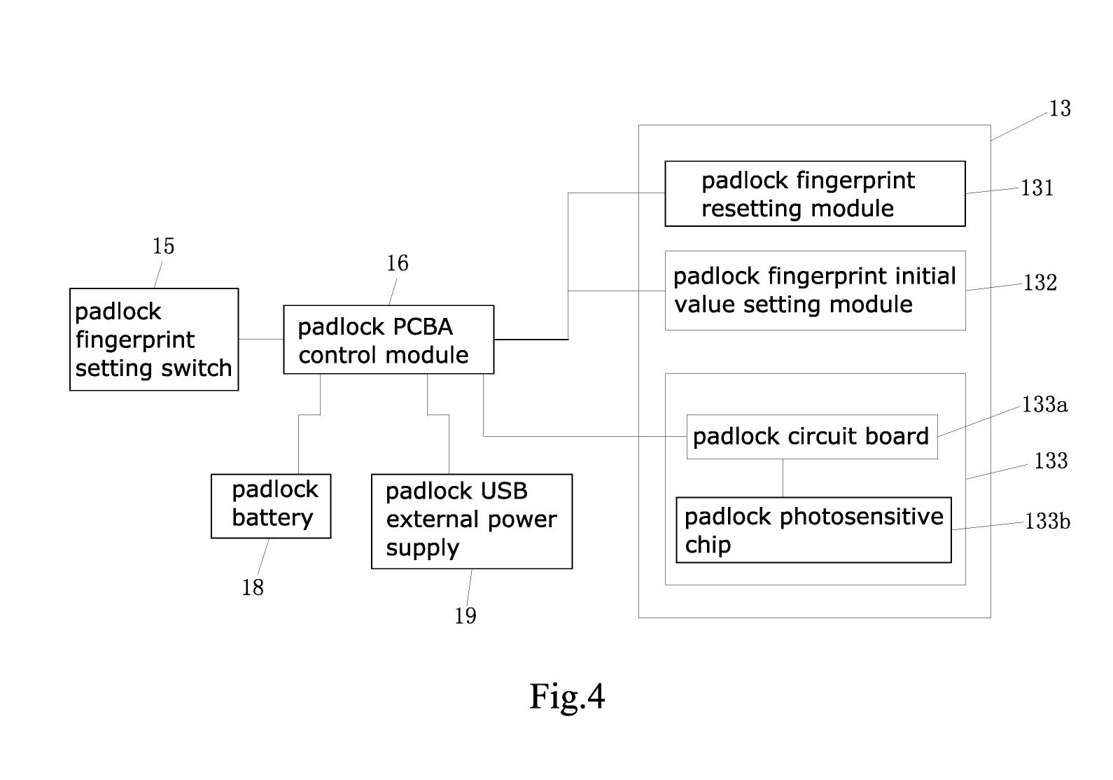

See FIGS. 1-4, a padlock 1 of this embodiment comprises a padlock housing 11 and a shackle 12. The padlock housing 11 is only equipped with a padlock fingerprint module 13. One end of shackle 12 is a rotatable end. The rotatable end is located in the padlock housing 11 and rotatable. A padlock resetting component 14 is mounted at the bottom of rotatable end of shackle 12. As well as a padlock fingerprint setting switch 15 and a padlock PCBA control module 16 for processing the signal of padlock fingerprint module 13. The padlock fingerprint setting switch 15 is located on one side of padlock resetting component 14 and under the rotatable end of shackle 12. The padlock fingerprint setting switch 15 is connected to the signal input end of padlock PCBA control module 16. The padlock fingerprint module 13 comprises a padlock fingerprint resetting module 131 and a padlock fingerprint initial value setting module 132. The padlock fingerprint resetting module 131 and padlock fingerprint initial value setting module 132 are connected to the signal output end of padlock PCBA control module 16 respectively. The shackle 12 can touch padlock fingerprint setting switch 15 under an external force. The padlock PCBA control module 16 can activate padlock fingerprint resetting module 131 and padlock fingerprint initial value setting module 132 when the padlock fingerprint setting switch 15 is activated. The shackle 12 is recovered automatically by the lower spring-like padlock resetting component 14.

The operating principle of padlock 1 on resetting fingerprint/initial value setting is that when padlock 1 is in opening state, the shackle 12 of padlock 1 is turned 180° against the lock state and pressed down, so that the bottom of shackle 12 touches the fingerprint setting switch, the padlock fingerprint setting switch 15 makes the padlock PCBA control module 16 generate a loop by line connection, so as to implement fingerprint initial value setting or fingerprint resetting.

Where a semicircular boss 121 is located in the lower end of rotatable end of shackle 12, as shown in the figure, the boss 121 is semicircular “C”, preventing rotation error to some extent. In addition, the padlock fingerprint module 13 has a padlock fingerprint trigger module 133. The padlock fingerprint trigger module 133 comprises a padlock circuit board 133a and a padlock photosensitive chip 133b. The padlock photosensitive chip 133b is fixed with glue to the chip substrate of padlock circuit board 133a. The padlock photosensitive chip 133b is electrically connected to padlock circuit board 133a by bonding. A padlock trigger switch tab 17 is mounted outside padlock housing 11. The padlock trigger switch tab 17 is located between padlock housing 11 and padlock fingerprint module 13. The padlock circuit board 133a is connected to padlock PCBA control module 16 via padlock trigger switch tab 17 to form a loop. When a finger presses the padlock fingerprint trigger module 133 of padlock fingerprint module 13, the padlock fingerprint trigger module 133 connects padlock PCBA control module 16 to padlock circuit board 133a to form a loop, the fingerprint program power switch is activated to read fingerprint information. In 30 seconds after the finger is removed (time is preset by program), the padlock PCBA control module 16 is powered off automatically to save electricity. The padlock PCBA control module 16 is connected to padlock fingerprint trigger module 133 for signal processing and program processing, the shackle 12 of padlock can be unlocked or locked directly. When the fingerprint information read by padlock fingerprint trigger module 133 is consistent with the preset fingerprint information, the drive circuit exports electrical signal to turn shackle 12 for unlocking.

In addition, there are padlock module protection components around and above bonding zone. The padlock module protection component is holder, IR and so on, for protecting padlock photosensitive chip 133b, padlock circuit board 133a and connecting line.

The padlock 1 has a padlock battery 18 and a padlock USB external power supply 19. The padlock battery 18 and padlock USB external power supply 19 are connected to padlock PCBA control module 16 respectively. The padlock battery 18 and padlock USB external power supply 19 provide a mobile power supply for padlock fingerprint module 13 and padlock PCBA control module 16. The padlock USB external power supply 19 provides an external power supply, mobile phone charge mode and data transfer for fingerprint lock. When the electric quantity is insufficient for startup, the door lock can be opened by using external power supply.

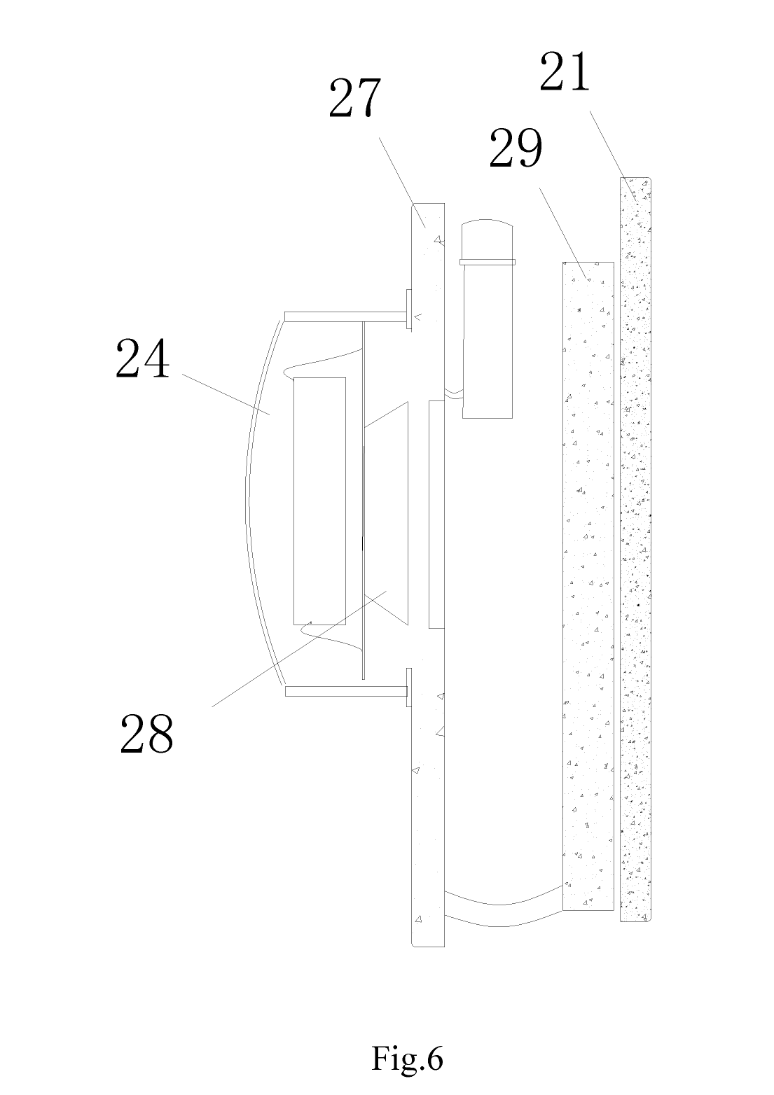

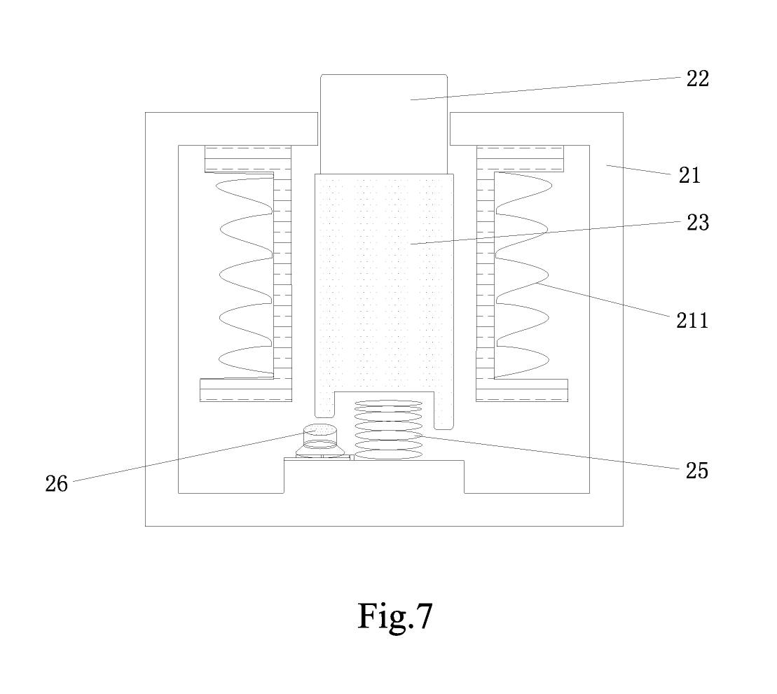

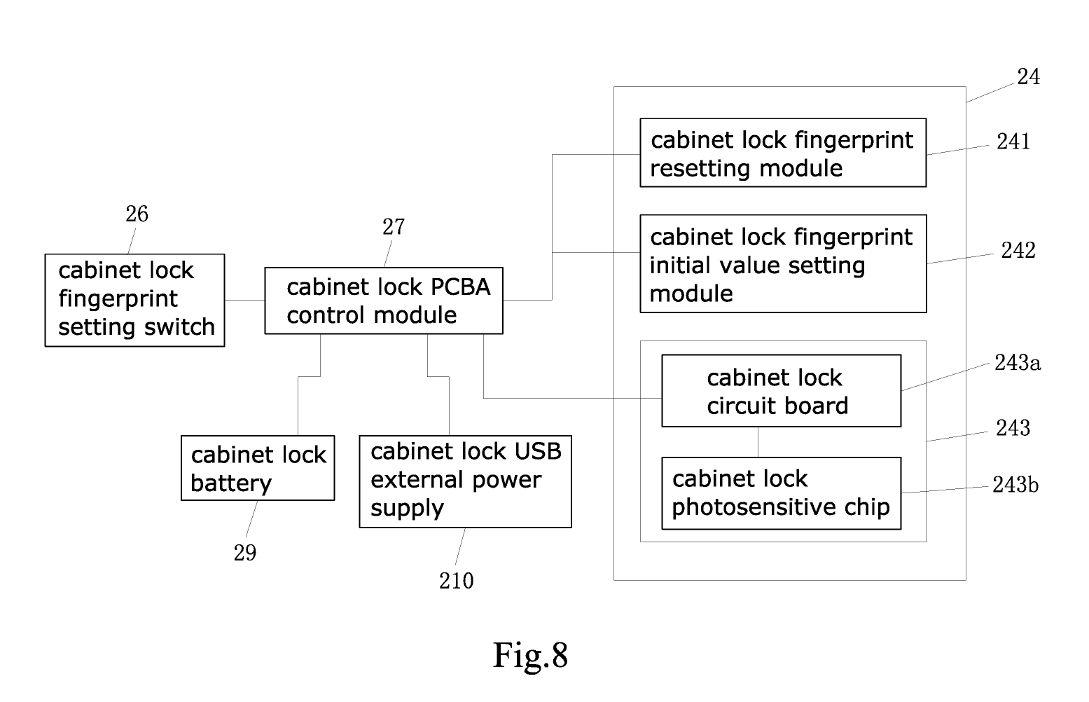

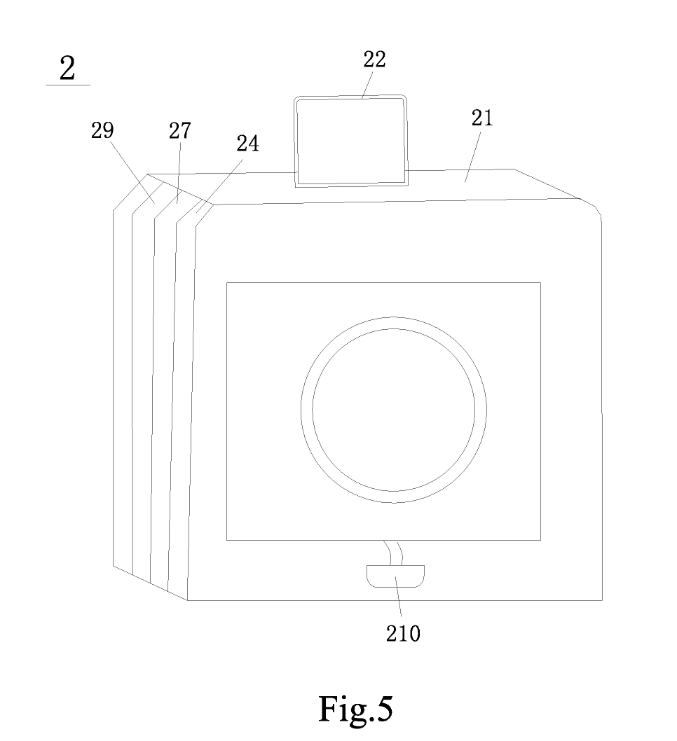

See FIGS. 5-8, a cabinet lock comprises a cabinet lock housing 21, a bolt 22 and a lock barrel 23. There is only one cabinet lock fingerprint module 24 on cabinet lock housing 21. The lock barrel 23 is embedded in cabinet lock housing 21. A cabinet lock resetting component 25 is mounted at the bottom of lock barrel 23. The bolt 22 is mounted above lock barrel 23. As well as a cabinet lock fingerprint setting switch 26 and a cabinet lock PCBA control module 27 for processing cabinet lock fingerprint module 24 signal and controlling bolt 22. The cabinet lock fingerprint setting switch 26 is mounted on one side of cabinet lock resetting component 25 and under lock barrel 23. The cabinet lock fingerprint setting switch 26 is connected to the signal input end of cabinet lock PCBA control module 27. The cabinet lock fingerprint module 24 has a cabinet lock fingerprint resetting module 241 and a cabinet lock fingerprint initial value setting module 242 and a cabinet lock fingerprint initial value setting module 242. The cabinet lock fingerprint resetting module 241 and cabinet lock fingerprint initial value setting module 242 are connected to the signal output end of cabinet lock PCBA control module 27 respectively. The bolt 22 is electrically connected to cabinet lock PCBA control module 27 via electromagnetic coil 211. The bolt 22 is stretched out or drawn back under electromagnetic control and can drive the lock barrel 23 to press down to touch cabinet lock fingerprint setting switch 26. The cabinet lock PCBA control module 27 can activate cabinet lock fingerprint resetting module 241 and cabinet lock fingerprint initial value setting module 242 when the cabinet lock fingerprint setting switch 26 is activated.

The operating principle of cabinet lock on resetting fingerprint/initial value setting is that when the cabinet lock is in opening state, the bolt 22 is pressed down, the linkage component lock barrel 23 touches the cabinet lock fingerprint setting switch 26 inside cabinet lock housing 21. The cabinet lock fingerprint setting switch 26 makes PCBA control board generate a loop by line connection, so as to implement fingerprint initial value setting or fingerprint resetting. When the setting is finished, stop pressing down, the bolt 22 linkage component lock barrel 23 is recovered automatically by the lower spring-like cabinet lock resetting component 25.

In like manner, a boss 231 is mounted in the lower end of lock barrel 23 in the cabinet lock.

In addition, the cabinet lock fingerprint module 24 has a cabinet lock fingerprint trigger module 243. The cabinet lock fingerprint trigger module 243 comprises a cabinet lock circuit board 243a and a cabinet lock photosensitive chip 243b. The cabinet lock photosensitive chip 243b is fixed with glue to the chip substrate of cabinet lock circuit board 243a. The cabinet lock photosensitive chip 243b is electrically connected to cabinet lock circuit board 243a by bonding. A cabinet lock trigger switch tab 28 is mounted outside cabinet lock housing 21. The cabinet lock trigger switch tab 28 is located between cabinet lock housing 21 and cabinet lock fingerprint module 24. The cabinet lock circuit board 243a is connected to cabinet lock PCBA control module 27 via cabinet lock trigger switch tab 28 to form a loop. When a finger presses the cabinet lock fingerprint trigger module 243 of cabinet lock fingerprint module 24, the cabinet lock fingerprint trigger module 243 connects cabinet lock PCBA control module 27 to cabinet lock circuit board 243a to form a loop, the fingerprint program power switch is activated to read fingerprint information. In 30 seconds after the finger is removed (time is preset by program), the cabinet lock PCBA control module 27 is powered off automatically to save electricity. The cabinet lock PCBA control module 27 is connected to cabinet lock fingerprint trigger module 243 for signal processing and program processing, the scaling of cabinet lock can be controlled directly. When the fingerprint information read from cabinet lock fingerprint trigger module 243 is consistent with the preset fingerprint information, the drive circuit exports electrical signal to retract bolt 22 for unlocking. When the power is off, the mechanical part, such as spring, rebounds the bolt 22 automatically for locking.

Where there are cabinet lock module protection components around and above bonding zone. The cabinet lock module protection component is holder or/and IR, for protecting cabinet lock photosensitive chip 243b, cabinet lock circuit board 243a and connecting line.

The cabinet lock has a cabinet lock battery 29 and a cabinet lock USB external power supply 210. The cabinet lock battery 29 and cabinet lock USB external power supply 210 are connected to cabinet lock PCBA control module 27 respectively. The cabinet lock battery 29 and cabinet lock USB external power supply 210 provide a mobile power supply for cabinet lock fingerprint module 24 and cabinet lock PCBA control module 27. The cabinet lock USB external power supply 210 provides an external power supply, mobile phone charge mode and data transfer for fingerprint lock. When the electric quantity is insufficient for startup, the door lock can be opened by using external power supply.

Although the invention has been explained in relation to its preferred embodiment, it is to be understood that many other possible modifications and variations can be made without departing from the spirit and scope of the invention as hereinafter claimed.

I claim:

1. A padlock, comprising a padlock housing and a shackle; there is only one padlock fingerprint module on said padlock housing; one end of said shackle is a rotatable end; said rotatable end is located in the padlock housing and rotatable; a padlock resetting component is mounted at the bottom of rotatable end of said shackle; as well as a padlock fingerprint setting switch and a padlock PCBA control module; said padlock fingerprint setting switch is located on one side of padlock resetting component and under the rotatable end of shackle; said padlock fingerprint setting switch is connected to the signal input end of padlock PCBA control module; said padlock fingerprint module comprises a padlock fingerprint resetting module and a padlock fingerprint initial value setting module; said padlock fingerprint resetting module and padlock fingerprint initial value setting module are connected to the signal output end of padlock PCBA control module respectively; said shackle can touch the padlock fingerprint setting switch under a downward external force; said padlock PCBA control module can activate padlock fingerprint resetting module and padlock fingerprint initial value setting module when the padlock fingerprint setting switch is activated.

2. The padlock defined in claim 1, wherein a semicircular boss is mounted in the lower end of rotatable end of said shackle, said boss corresponds to padlock fingerprint setting switch up and down.

3. The padlock defined in claim 1, wherein said padlock fingerprint module has a padlock fingerprint trigger module; said padlock fingerprint trigger module comprises a padlock circuit board and a padlock photosensitive chip; said padlock photosensitive chip is fixed with glue to the chip substrate of padlock circuit board; said padlock photosensitive chip is electrically connected to padlock circuit board by bonding; a padlock trigger switch tab is mounted outside said padlock housing; said padlock trigger switch tab is located between padlock housing and padlock fingerprint module; said padlock circuit board is connected to padlock PCBA control module via padlock trigger switch tab to form a loop.

4. The padlock defined in claim 3, wherein there are padlock module protection components around and above the bonding zone; said padlock module protection component is holder or/and IR.

5. The padlock defined in claim 1, wherein includes a padlock battery and a padlock USB external power supply; said padlock battery and padlock USB external power supply are connected to padlock PCBA control module respectively.

6. A cabinet lock, comprising a cabinet lock housing, a bolt and a lock barrel; there is only one cabinet lock fingerprint module on said cabinet lock housing; said lock barrel is located in the cabinet lock housing; a cabinet lock resetting component is mounted at the bottom of said lock barrel; said bolt is mounted above the lock barrel; as well as a cabinet lock fingerprint setting switch and a cabinet lock PCBA control module; said cabinet lock fingerprint setting switch is mounted on one side of cabinet lock resetting component and under the lock barrel; said cabinet lock fingerprint setting switch is connected to the signal input end of cabinet lock PCBA control module; said cabinet lock fingerprint module comprises a cabinet lock fingerprint resetting module and a cabinet lock fingerprint initial value setting module; said cabinet lock fingerprint resetting module and cabinet lock fingerprint initial value setting module are connected to the signal output end of cabinet lock PCBA control module respectively; said bolt is electrically connected to the cabinet lock PCBA control module via electromagnetic coil; said bolt is stretched out or drawn back under electromagnetic control and can drive the lock barrel to press down to touch cabinet lock fingerprint setting switch; said cabinet lock PCBA control module can activate cabinet lock fingerprint resetting module and cabinet lock fingerprint initial value setting module when the cabinet lock fingerprint setting switch is activated.

7. The cabinet lock defined in claim 6, wherein a boss is mounted in the lower end of said lock barrel, said boss corresponds to cabinet lock fingerprint setting switch up and down.

8. The cabinet lock defined in claim 6, wherein said cabinet lock fingerprint module has a cabinet lock fingerprint trigger module; said cabinet lock fingerprint trigger module comprises a cabinet lock circuit board and a cabinet lock photosensitive chip; said cabinet lock photosensitive chip is fixed with glue to the chip substrate of cabinet lock circuit board; said cabinet lock photosensitive chip is electrically connected to the cabinet lock circuit board by bonding; a cabinet lock trigger switch tab is mounted outside said cabinet lock housing; said cabinet lock trigger switch tab is located between cabinet lock housing and cabinet lock fingerprint module; said cabinet lock circuit board is connected to cabinet lock PCBA control module via cabinet lock trigger switch tab to form a loop.

9. The cabinet lock defined in claim 8, wherein there are cabinet lock module protection components around and above the bonding zone; said cabinet lock module protection component is holder or/and IR.

10. The cabinet lock defined in claim 6, wherein includes a cabinet lock battery and a cabinet lock USB external power supply; said cabinet lock battery and cabinet lock USB external power supply are connected to cabinet lock PCBA control module respectively.
